(19) United States
(12) Patent Application Publication
(10) Pub. No.: US 2026/0099832 A1
(43) Pub. Date: Apr. 9, 2026

(54) AEROSOL PROVISION SYSTEM WITH TRANSACTION FUNCTIONALITY

(71) Applicant: NICOVENTURES TRADING LIMITED, London (GB)

(72) Inventors: Laziz TURAKULOV, London (GB); Darryl BAKER, London (GB); Patrick MOLONEY, London (GB)

(21) Appl. No.: 19/114,042

(22) PCT Filed: Sep. 20, 2023
(86) PCT No.: PCT/GB2023/052440

§ 371 Date: Mar. 21, 2025

(30) Foreign Application Priority Data
Sep. 22, 2022 (GB) 2213832.5

(51) Int. Cl. G06Q 20/30; A24F 40/50; A24F 40/65; G06Q 20/20; G06Q 20/38; H04B 11/00

(52) U.S. Cl. CPC G06Q 20/3272; A24F 40/50; A24F 40/65; G06Q 20/20; G06Q 20/308; G06Q 20/3829; H04B 11/00

(57) ABSTRACT

A device component for an aerosol provision system comprises: a speaker operable to emit acoustic signals; and a controller configured to: supply to the speaker a drive signal in which is encoded payment entity information relating to a payment entity associated with a user, to cause the speaker to emit an acoustic signal carrying the payment entity information for detection by a point-of-sale payment transaction system.

### TECHNICAL FIELD

The present disclosure relates to an aerosol provision system, or part thereof, having transaction functionality, and a method for performing a transaction using an aerosol provision system.

### BACKGROUND

Aerosol provision systems are often small handheld devices that a user typically carries with them in order to have access to the provided aerosol whenever required or desired. While some systems are very simple, more recent systems can include a processor or controller in order to control operation of the system in order to give optimised and adjustable aerosol generation. The controller may include software for this purpose. Accordingly, an aerosol provision system can be readily adaptable for the expansion of its functionality, by modification of the controller and any programming associated with the controller in order to allow the system to perform additional functions. Since the system is likely to be carried regularly by the user, functionality relating to typical actions and requirements of the user can be usefully incorporated in an aerosol provision system so as to be easily accessible for the user at any time.

Accordingly, techniques for configuring aerosol provision systems for expanded functionality are of interest.

### SUMMARY

According to a first aspect of some embodiments described herein, there is provided a device component for an aerosol provision system, the device component comprising: a speaker operable to emit acoustic signals; and a controller configured to supply to the speaker a drive signal in which is encoded payment entity information relating to a payment entity associated with a user, to cause the speaker to emit an acoustic signal carrying the payment entity information for detection by a point-of-sale payment transaction system.

According to a second aspect of some embodiments described herein, there is provided an aerosol provision system comprising a device component according to the first aspect

According to a third aspect of some embodiments described herein, there is provided a method of enabling a payment transaction, comprising generating a drive signal for a speaker in an aerosol provision system, in which is encoded payment entity information relating to a payment entity associated with a user; supplying the drive signal to the speaker to cause the speaker to emit an acoustic signal carrying the payment entity information; detecting the acoustic signal at a point-of-sale system; and extracting the payment entity information from the acoustic signal.

These and further aspects of the certain embodiments are set out in the appended independent and dependent claims. It will be appreciated that features of the dependent claims may be combined with each other and features of the independent claims in combinations other than those explicitly set out in the claims. Furthermore, the approach described herein is not restricted to specific embodiments such as set out below, but includes and contemplates any appropriate combinations of features presented herein. For example, an aerosol provision system or part thereof, or a related method, may be provided in accordance with approaches described herein which includes any one or more of the various features described below as appropriate.

### BRIEF DESCRIPTION OF THE DRAWINGS

Various embodiments of the invention will now be described in detail by way of example only with reference to the following drawings in which:

FIG. 1 shows a simplified schematic cross-section through an example electronic aerosol provision system in which embodiments of the present disclosure can be implemented;

FIG. 2 shows a simplified schematic cross-sectional view through a first example of a device component for an aerosol provision system according to an embodiment of the present disclosure;

FIG. 3 shows a simplified schematic representation of an example apparatus for carrying out an electronic financial transaction using an aerosol provision system according to an embodiment of the present disclosure;

FIG. 4 shows a flow chart of steps in an example method for carrying out an electronic financial transaction using an aerosol provision system according to an embodiment of the present disclosure; and

FIG. 5 shows a simplified schematic cross-sectional view through a second example of a device component for an aerosol provision system according to an embodiment of the present disclosure.

### DETAILED DESCRIPTION

Aspects and features of certain examples and embodiments are discussed/described herein. Some aspects and features of certain examples and embodiments may be implemented conventionally and these are not discussed/described in detail in the interests of brevity. It will thus be appreciated that aspects and features of apparatus and methods discussed herein which are not described in detail may be implemented in accordance with any conventional techniques for implementing such aspects and features.

As described above, the present disclosure relates to (but is not limited to) aerosol or vapour provision systems, including electronic systems such as e-cigarettes. Throughout the following description the terms “e-cigarette” and “electronic cigarette” may sometimes be used; however, it will be appreciated these terms may be used interchangeably with aerosol (vapour) provision system. The systems are intended to generate an inhalable aerosol by vaporisation of a substrate (aerosol-generating material) in the form of a liquid or gel which may or may not contain nicotine. Additionally, hybrid systems may comprise a liquid or gel substrate plus a solid substrate which is also heated. The solid substrate may be for example tobacco or other non-tobacco products, which may or may not contain nicotine. The terms “aerosol-generating material” and “aerosolisable material” as used herein are intended to refer to materials which can form an aerosol, either through the application of heat or some other means. The term “aerosol” may be used interchangeably with “vapour”.

As used herein, the terms “system” and “delivery system” are intended to encompass systems that deliver a substance to a user, and include non-combustible aerosol provision systems that release compounds from an aerosolisable material without combusting the aerosolisable material, such as electronic cigarettes, tobacco heating products, and hybrid systems to generate aerosol using a combination of aerosolisable materials, and articles comprising aerosolisable material and configured to be used within one of these non-combustible aerosol provision systems. According to the present disclosure, a “non-combustible” aerosol provision system is one where a constituent aerosolisable material of the aerosol provision system (or component thereof) is not combusted or burned in order to facilitate delivery to a user. In some embodiments, the delivery system is a non-combustible aerosol provision system, such as a powered non-combustible aerosol provision system. In some embodiments, the non-combustible aerosol provision system is an electronic cigarette, also known as a vaping device or electronic nicotine delivery (END) system, although it is noted that the presence of nicotine in the aerosolisable material is not a requirement. In some embodiments, the non-combustible aerosol provision system is a hybrid system to generate aerosol using a combination of aerosolisable materials, one or a plurality of which may be heated. Each of the aerosolisable materials may be, for example, in the form of a solid, liquid or gel and may or may not contain nicotine. In some embodiments, the hybrid system comprises a liquid or gel aerosolisable material and a solid aerosolisable material. The solid aerosolisable material may comprise, for example, tobacco or a non-tobacco product.

Typically, the non-combustible aerosol provision system may comprise a non-combustible aerosol provision device and an article (consumable) for use with the non-combustible aerosol provision device. However, it is envisaged that articles which themselves comprise a means for powering an aerosol generator or aerosol generating component may themselves form the non-combustible aerosol provision system. In some embodiments, the non-combustible aerosol provision device may comprise a power source and a controller. The power source may, for example, be an electric power source. In some embodiments, the article for use with the non-combustible aerosol provision device may comprise an aerosolisable material, an aerosol generating component (aerosol generator), an aerosol generating area, a mouthpiece, and/or an area for receiving aerosolisable material.

In some systems the aerosol generating component or aerosol generator comprises a heater capable of interacting with the aerosolisable material so as to release one or more volatiles from the aerosolisable material to form an aerosol. However, the disclosure is not limited in this regard, and applies also to systems that use other approaches to form aerosol, such as a vibrating mesh.

In some embodiments, the article for use with the non-combustible aerosol provision device may comprise aerosolisable material or an area for receiving aerosolisable material. In some embodiments, the article for use with the non-combustible aerosol provision device may comprise a mouthpiece. The area for receiving aerosolisable material may be a storage area for storing aerosolisable material. For example, the storage area may be a reservoir. In some embodiments, the area for receiving aerosolisable material may be separate from, or combined with, an aerosol generating area.

As used herein, the term “component” may be used to refer to a part, section, unit, module, assembly or similar of an electronic cigarette or similar device that incorporates several smaller parts or elements, possibly within an exterior housing or wall. An aerosol provision system such as an electronic cigarette may be formed or built from one or more such components, such as an article and a device, and the components may be removably or separably connectable to one another, or may be permanently joined together during manufacture to define the whole system. The present disclosure is applicable to (but not limited to) systems comprising two components separably connectable to one another and configured, for example, as an article in the form of an aerosolisable material carrying component holding liquid or another aerosolisable material (alternatively referred to as a cartridge, cartomiser, pod or consumable), and a device having a battery or other power source for providing electrical power to operate an aerosol generating component or aerosol generator for creating vapour/aerosol from the aerosolisable material. A component may include more or fewer parts than those included in the examples.

In some examples, the present disclosure relates to aerosol provision systems and components thereof that utilise aerosolisable material in the form of a liquid or a gel which is held in a storage area such as a reservoir, tank, container or other receptacle comprised in the system, or absorbed onto a carrier substrate. An arrangement for delivering the material from the reservoir for the purpose of providing it to an aerosol generator for vapour/aerosol generation is included. The terms “liquid”, “gel”, “fluid”, “source liquid”, “source gel”, “source fluid” and the like may be used interchangeably with terms such as “aerosol-generating material”, “aerosolisable substrate material” and “substrate material” to refer to material that has a form capable of being stored and delivered in accordance with examples of the present disclosure.

FIG. 1 is a highly schematic diagram (not to scale) of a generic example electronic aerosol/vapour provision system such as an e-cigarette 10, in which aspects of the present disclosure may be embodied and which is presented for the purpose of showing the relationship between the various parts of a typical system and explaining the general principles of operation. Note that the present disclosure is not limited to a system configured in this way, and features may be modified in accordance with the various alternatives and definitions described above and/or apparent to the skilled person. The e-cigarette 10 has a generally elongate shape in this example, extending along a longitudinal axis indicated by a dashed line, and comprises two main components, namely a device 20 (control or power component, section or unit), and an article or consumable 30 (cartridge assembly or section, sometimes referred to as a cartomiser or clearomiser) carrying aerosol-generating material and operating to generate vapour/aerosol.

The article 30 includes a storage area such as a reservoir 3 containing a source liquid or other aerosol-generating material comprising a formulation such as liquid or gel from which an aerosol is to be generated, for example containing nicotine. As an example, the source liquid may comprise around 1% to 3% nicotine and 50% glycerol, with the remainder comprising roughly equal measures of water and propylene glycol, and possibly also comprising other components, such as flavourings. Nicotine-free source liquid may also be used, such as to deliver flavouring. A solid substrate (not illustrated), such as a portion of tobacco or other flavour element through which vapour generated from the liquid is passed, may also be included. The reservoir 3 may have the form of a storage tank, being a container or receptacle in which source liquid can be stored such that the liquid is free to move and flow within the confines of the tank. For a consumable article, the reservoir 3 may be sealed after filling during manufacture so as to be disposable after the source liquid is consumed; otherwise, it may have an inlet port or other opening through which new source liquid can be added by the user. The article 30 also comprises an aerosol generator 5, comprising in this example an aerosol generating component, which may have the form of an electrically powered heating element or heater 4 and an aerosol-generating material transfer component 6. The heater 4 is located externally of the reservoir 3 and is operable to generate the aerosol by vaporisation of the source liquid by heating. The aerosol-generating material transfer component 6 is a transfer or delivery arrangement configured to deliver aerosol-generating material from the reservoir 3 to the heater 4. In some examples, it may have the form of a wick or other porous element. A wick 6 may have one or more parts located inside the reservoir 3, or otherwise be in fluid communication with liquid in the reservoir 3, so as to be able to absorb source liquid and transfer it by wicking or capillary action to other parts of the wick 6 that are adjacent or in contact with the heater 4. This liquid is thereby heated and vaporised, and replacement liquid drawn, via continuous capillary action, from the reservoir 3 for transfer to the heater 4 by the wick 6. The wick may be thought of as a conduit between the reservoir 3 and the heater 4 that delivers or transfers liquid from the reservoir to the heater. In some designs, the heater 4 and the aerosol-generating material transfer component 6 are unitary or monolithic, and formed from a same material that is able to be used for both liquid transfer and heating, such as a material which is both porous and conductive. In still other cases, the aerosol-generating material transfer component may operate other than by capillary action, such as by comprising an arrangement of one or more valves by which liquid may exit the reservoir 3 and be passed onto the heater 4.

A heater and wick (or similar) combination, referred to herein as an aerosol generator 5, may sometimes be termed an atomiser or atomiser assembly, and the reservoir with its source liquid plus the atomiser may be collectively referred to as an aerosol source. Various designs are possible, in which the parts may be differently arranged compared with the highly schematic representation of FIG. 1. For example, and as mentioned above, the wick 6 may be an entirely separate element from the heater 4, or the heater 4 may be configured to be porous and able to perform at least part of the wicking function directly (a metallic mesh, for example). If the system is an electronic system, the heater 4 may comprise one or more electrical heating elements that operate by ohmic/resistive (Joule) heating, although inductive heating may also be used, in which case the heater comprises a susceptor in an induction heating arrangement. In general, therefore, an atomiser or aerosol generator, in the present context, can be considered as one or more elements that implement the functionality of a vapour-generating element able to generate vapour by heating source liquid (or other aerosol-generating material) delivered to it, and a liquid transport or delivery element able to deliver or transport liquid from a reservoir or similar liquid store to the vapour-generating element by a wicking action/capillary force or otherwise. An aerosol generator is typically housed in an article 30 of an aerosol generating system, as in FIG. 1, but in some examples, at least the heater part may be housed in the device 20. Embodiments of the disclosure are applicable to all and any such configurations which are consistent with the examples and description herein.

Returning to FIG. 1, the article 30 also includes a mouthpiece or mouthpiece portion 35 having an opening or air outlet through which a user may inhale the aerosol generated by the heater 4.

The device 20 includes a cell or battery 7 (referred to hereinafter as a battery, and which may or may not be re-chargeable) to provide electrical power for electrical components of the e-cigarette 10, in particular to operate the heater 4. Additionally, there is a controller 8 such as a printed circuit board and/or other electronics or circuitry for generally controlling the e-cigarette. The controller may include a processor programmed with software, which may be modifiable by a user of the system. The control electronics/circuitry 8 operates the heater 4 using power from the battery 7 when vapour is required. At this time, the user inhales on the system 10 via the mouthpiece 35, and air A enters through one or more air inlets 9 in the wall of the device 20 (air inlets may alternatively or additionally be located in the article 30). When the heater 4 is operated, it vaporises source liquid delivered from the reservoir 3 by the aerosol-generating material transfer component 6 to generate the aerosol by entrainment of the vapour into the air flowing through the system, and this is then inhaled by the user through the opening in the mouthpiece 35. The aerosol is carried from the aerosol generator 5 to the mouthpiece 35 along one or more air channels (not shown) that connect the air inlets 9 to the aerosol generator 5 to the air outlet when a user inhales on the mouthpiece 35.

More generally, the controller 8 is suitably configured/programmed to control the operation of the aerosol provision system to provide functionality in accordance with embodiments and examples of the disclosure as described further herein, as well as for providing conventional operating functions of the aerosol provision system in line with established techniques for controlling such devices. The controller 8 may be considered to logically comprise various sub-units/circuitry elements associated with different aspects of the aerosol provision system's operation in accordance with the principles described herein and other conventional operating aspects of aerosol provision systems, such as display driving circuitry for systems that may include a user display such as an screen or indicator lights, and user input detections via one or more user actuable controls 12. It will be appreciated that the functionality of the controller 8 can be provided in various different ways, for example using one or more suitably programmed programmable computers and/or one or more suitably configured application-specific integrated circuits/circuitry/chips/chipsets configured to provide the desired functionality.

The device 20 and the article 30 are separate connectable parts detachable from one another by separation in a direction parallel to the longitudinal axis, as indicated by the double-headed arrows in FIG. 1. The components 20, 30 are joined together when the device 10 is in use by cooperating engagement elements 21, 31 (for example, a screw or bayonet fitting) which provide mechanical and in some cases electrical connectivity between the device 20 and the article 30. Electrical connectivity is required if the heater 4 operates by ohmic heating, so that current can be passed through the heater 4 when it is connected to the battery 5. In systems that use inductive heating, electrical connectivity can be omitted if no parts requiring electrical power are located in the article 30. An inductive work coil can be housed in the device 20 and supplied with power from the battery 5, and the article 30 and the device 20 shaped so that when they are connected, there is an appropriate exposure of the heater 4 to flux generated by the coil for the purpose of generating current flow in the material of the heater. The FIG. 1 design is merely an example arrangement, and the various parts and features may be differently distributed between the device 20 and the article 30, and other components and elements may be included. The two sections may connect together end-to-end in a longitudinal configuration as in FIG. 1, or in a different configuration such as a parallel, side-by-side arrangement. The system may or may not be generally cylindrical and/or have a generally longitudinal shape. Either or both sections or components may be intended to be disposed of and replaced when exhausted (the reservoir is empty or the battery is flat, for example), or be intended for multiple uses enabled by actions such as refilling the reservoir and recharging the battery. In other examples, the system 10 may be unitary, in that the parts of the device 20 and the article 30 are comprised in a single housing and cannot be separated. Embodiments and examples of the present disclosure are applicable to any of these configurations and other configurations of which the skilled person will be aware.

In accordance with the present disclosure, an aerosol provision system is configured with the capability to enable a user to make financial transactions in addition to being configured to generate aerosol. The user will typically carry an aerosol provision system all or most of the time, and will likely have it to hand when making a purchase in a retail outlet. Accordingly, it is proposed to configure an aerosol provision system to hold information relating to a payment entity belonging to the user or which the user is authorised to use or access, and be able to exchange the information with a point-of-sale system in order to facilitate a payment for the user. In this way, the user no longer needs to carry other payment-facilitating items or equipment, such as credit and debit cards or a mobile phone enabled with a payment app, or cash. Arrangements such as this where an electronic device is enabled to perform a financial transaction in place of a physical payment card by storing information relating to the card or to a financial account can be referred to as “electronic wallets” or “e-wallets”.

In particular, it is proposed that the aerosol provision system is configured to enable a financial transaction by the use of audio signals, by which the aerosol provision system communicates with a point-of-sale system, for example installed at a retail outlet. Previously, it was necessary for payment cards such as debit cards and credit cards to make physical contact with a terminal of a point-of-sale system in order for the point-of-sale system to be able to “read” or obtain relevant information stored in the card which was used by the point-of-sale system to perform the required financial transaction to enable a purchase, in other words deduction of the purchase price of an item being purchased by the user from a financial asset (credit or debit balance) associated with the user and held by a bank or other financial institution. More recently, this payment process has been supplemented by so-called “contactless payment” in which it is merely necessary for the user to hold the payment card close to the point-of-sale terminal for the terminal to be able to obtain the required information and enable the purchase. As well as having advantages such as ease, speed and simplicity compared to physical contact card reading arrangements, contactless payments have allowed the payment mechanism to be separated from the actual payment card, and instead embodied in an electronic device able to hold the same relevant information and exchange it with a point-of-sale terminal when the device is held near to the terminal. Mobile telephones (cell phones) are commonly used for this purpose.

Near-field-communication (NFC) is a technology standard commonly used to enable contactless payments. NFC comprises a set of communication protocols to allow communication between two NFC-enabled entities by radio frequencies over very small distances—4 cm or less. For contactless payments, the point-of-sale terminal is configured as a NFC entity which is able to read information from a NFC tag on a payment card which stores the relevant information required for payment, or able to communicate with an NFC-enabled electronic device such as a mobile telephone in order to receive the relevant information from a contactless payment app on the electronic device. NFC does not use any encryption for the communication channel between the two entities because the extreme physical proximity required is considered to provide sufficient security. However, any unencrypted communication is necessarily at some risk of interception. Also, appropriate compatibility, software drivers and the like are required for a mobile telephone to be used for this purpose.

An alternative technology for contactless payment is Bluetooth, which is a wireless technology standard by which data such as payment data can be exchanged between two paired devices, such as a mobile telephone and a point-of-sale terminal, over distances up to about 10 m using ultrahigh frequency radio waves. The considerably longer range compared to NFC means that a variety of channel encryptions are employed to secure Bluetooth communications; this protection is clearly critical when the exchange of financial data is involved. The encryption can consume a non-negligible amount of power, so can impact on the battery life of a portable electronic device such as a mobile telephone. The electronic device must also be configured for Bluetooth compatibility to be used in this way.

The various requirements of NFC and/or Bluetooth would need to be met by an aerosol provision device if it was to be configured to enable payment transactions via these standards in a similar way to a mobile telephone.

The use of audio signals instead of NFC or Bluetooth for contactless payment with an aerosol provision device offers various advantages and avoids some potential problems. Audio signal generation and reception is a straightforward technique that can be implemented using simple components which are readily available and inexpensive, and can also be small so as not to occupy too much valuable space in a hand-held portable device. The software needed to operate via audio signal communication can also be simple and compact, thereby not requiring significant storage space in a device's memory and not requiring much power for execution. This is important in a portable device where maximum battery lifetime is an important characteristic for the user. The more complex software and operating system compatibility required to enable a device to use NFC or Bluetooth is avoided.

For security, which is of importance for applications involving the exchange of financial data, an audio signal (or audio transmission channel) can be encrypted in a straightforward manner using, for example, the existing and established encryption method of asymmetric cryptography. This is attractive compared to the unencrypted communications of NFC. Compared to the more complex encryption techniques required for Bluetooth, power consumption and associated battery drain can be much less, and compatibility with more detailed encryption is not necessary. The provision of a low power contactless payment technique is particularly attractive for an aerosol provision system, since aerosol generation can consume a relatively large amount of power, and battery capacity is necessarily limited in a portable device.

As discussed above, an aerosol provision system can comprise a device component housing a power supply (battery) and a controller or processor for controlling the system coupled to an article, cartridge or consumable component that contains a supply of aerosol-generating substrate material which is vaporised to generate the required aerosol. For practical, cost and environmental reasons, longer lifetime parts of the system tend to be housed in the device for multiple uses over a prolonged operating life, while shorter lifetime parts are housed in the consumable which will be replaced regularly. According to the present disclosure, parts relevant for audio signal communication are proposed to be located in the device for long-term usage, and also for security since confidential data is involved. However, this is not a limiting arrangement, and some or all of the parts might be placed in the consumable of a two-part system, or the system might be a one-part design in which the cartridge is not detachable from the device. Hence, the following description showing audio components in the device of an aerosol generating system is an example only and is not limiting; the various parts could be otherwise distributed within a system.

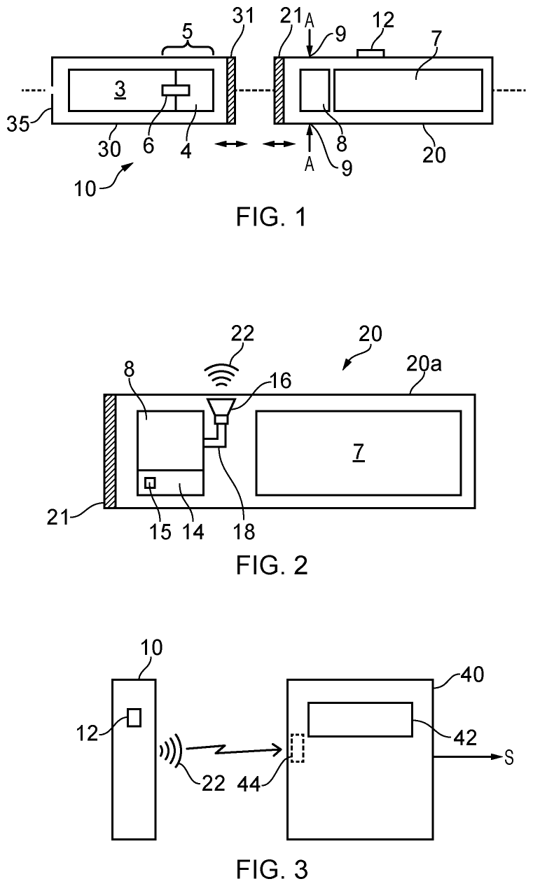

FIG. 2 shows a highly schematic longitudinal cross-sectional view through an example device or device component for an aerosol provision system configured for audio signal communication for the purpose of enabling a transaction. Note that in this disclosure, the terms “audio” and “acoustic” may be used interchangeably to denote the use of sound and sound waves, with the terms “audio signal” and “acoustic signal” indicating a sound wave deliberately configured to carry specified information (the sound wave is shaped in some way to encode the information) over a specified channel of communication from an acoustic or audio source or transmitter to an acoustic or audio detector or receiver.

In FIG. 2, the device 20 comprises, as before in FIG. 1, a housing 20a with a coupling arrangement 21 to allow an article or consumable component to be joined or connected to the device 20 to make a complete aerosol provision system. Inside the housing 20a is a battery 7 and a controller 8 which is configured to control operation of the aerosol generation system, including the supply of power from the battery 7 to electrical components of the system as required. Other elements of the device which may be present but which are not relevant to the present disclosure are omitted for clarity. A memory or data storage element 14 is associated with the controller 8. The memory 14 stores software which is executed by the controller in order to operate the aerosol provision system, and also stores various data or information representing values required for the execution of the software, such as power level settings for running a heating element. In some cases these may be pre-set values provided during manufacture for access by the controller when required. In other cases, the data may be input by a user of the device in order to customise or personalise the system. Such data may be input directly into the device via a user input interface (not shown) such as a touch screen, or may be transferred to the device from an external device such as a computer or a smartphone via a wired or wireless communications connection (the device being enabled with appropriate connectivity, also not shown). In particular according to the present disclosure, the memory stores payment entity information 15 relating to a payment entity associated with a user of the system.

A payment entity can be any item, physical or abstract, which allows a financial institution or organisation, or other facility enabled to oversee financial transactions, to control or access a financial balance or asset associated with the user, and which the user expects or intends to be able to draw on or utilise to make purchases. Examples of a payment entity include a debit card, a credit card, other payment cards such as a gift card or voucher, or a prepayment card, a bank or building society account (current account or savings account), a credit or debit balance, or other designated monetary pot or fund. The payment entity information relating to the payment entity is data or information which allows the financial facility to identify or locate the payment entity in order to arrange the deduction of a purchase price associated with a purchase from the financial balance associated with the user. As examples, for a debit card, credit card or other card types, the payment entity information may be the number of the card. For a bank account, the payment entity information may be the account number of the account and the sort code of the bank.

The device also includes a speaker 16, which is operable in the usual manner to emit acoustic signals 22 when provided with appropriate electrical drive signals via control lines 18. A speaker is a passive electrical element which is operated by drive signals alone, without requiring an additional power supply. Hence, it is a useful component for enabling an aerosol provision system, in which it is generally desirable to conserve battery power where possible, to emit communication signals. Depending on the amplitude (volume) and frequency of the acoustic signals which are emitted, the speaker 16 may be mounted behind a suitable aperture or window (not shown) in the housing 20a in order that the material of the housing does not attenuate the acoustic signal. In other cases, the acoustic signal 22 will be strong enough to transmit through the housing 20a so that no window is required; this simplifies construction and protects the speaker 22 from physical damage. The speaker 22 can be located wherever is convenient within the housing 20a, but usefully some consideration is given to location such that a user holding the device is less likely to block the emitted acoustic signal 22 with their hand, and the acoustic signal 22 is likely to be emitted in a direction towards a receiver (microphone) in a point-of-sale terminal.

The drive signal for the speaker 16 is generated by the controller 8, where the drive signal is a conventional electrical signal for driving a speaker, comprising a voltage/current applied to the speaker in order to move a diaphragm in speaker and cause sound emission. The controller 8 takes the payment entity information 15 stored in the memory 14 and encodes it in the drive signal, so that when driven by the drive signal, the speaker 16 emits a varying acoustic signal in which the payment entity information 15 is embedded and from which the payment entity information 15 can be determined or extracted by a receiving entity with knowledge of the encoding scheme used. The acoustic signal 22 therefore carries the payment entity information, and enables the payment entity information to be transmitted from the aerosol generating system to a point-of sale terminal.

The controller 8 may read the payment entity information 15 when it is first stored in the memory 14 (or when it is first required to be transmitted) and generate the associated drive signal, and then store the drive signal in the memory 14. In this way, the drive signal is immediately available for use when it is required to be transmitted for a transaction to be made. The drive signal itself may then be considered as the stored payment entity information which relates to the payment entity associated with the user. Alternatively, the controller 8 may read the payment entity information 15 each time a transaction is made and generate the drive signal on demand. This is more computationally expensive, but does allow other information to be included in the drive signal and the acoustic signal if and when required.

The payment entity information 15 can be encoded into the drive signal and hence the acoustic signal in any way. Amplitude modulation, frequency modulation, or a combination of the two may be used, so that the acoustic signal varies in volume and/or pitch in a way which reflects the embedded payment entity information. Also, the overall frequency range can be selected as preferred, for example in order to make the acoustic signal more or less perceptible to human listeners. For example, a frequency or frequencies in a range audible to humans, generally defined as 20 Hz to 20 kHz might be used. Use of audible frequencies, particularly towards the mid-part of this range (for example 200 Hz to 2 kHz) allows the user to perceive that the payment entity information has been transmitted, in other words that the aerosol provision system is working correctly in this regard so that the transaction should be implemented. However, in a busy retail environment, a plurality of audible audio signals might be deemed undesirable or obtrusive. Accordingly, the acoustic signal can be pitched in a non-audible frequency range, such as below 20 Hz (infrasonic frequencies or infrasound) or above 20 kHz (ultrasonic frequencies or ultrasound).

To achieve this, the controller 8 is provided with details of a suitable acoustic coding scheme which it applies to embed the payment entity information into the drive signal for operating the speaker 16. The point-of-sale system is also provided with the scheme details in order that it is able to extract the payment entity information from a received acoustic signal.

As noted, encryption may also be applied to the drive signal so that a transmitted acoustic signal cannot be easily read if it is intercepted en route to a point-of-sale terminal. This helps to protect the personal financial data which the payment entity information represents. The known technique of asymmetric cryptography is suitable for this, and is attractive as being established and straightforward, and hence not creating a computation burden and resulting drain of battery power. Other encryption approaches may be used as preferred, however. The controller uses a key for the encryption which is known to or derivable/obtainable by the point-of-sale system so that the received acoustic signal can be decrypted. Note that the encryption can be applied to the payment entity information, so that an encrypted version of the payment entity information is then encoded or translated into the drive signal and resulting acoustic signal. Alternatively, the encryption may be applied to the drive signal after it has been generated to reflect the unencrypted payment entity information. Either approach may be used as is considered convenient or practical, or most secure. For example, if an encryption scheme with a constantly updated key is employed, encryption of the drive signal may be preferred since this allows a pre-generated and stored version of the drive signal to be retrieved from memory and then encrypted using the current key each time a transaction is made. For an evolving key arrangement, the controller may be provided with new keys via software updates, or may be provided with software by which it creates the new keys as required. Any convenient encryption scheme may be used to protect the payment entity information if desired; the skilled person will be able to implement a suitable technique.

FIG. 3 shows a schematic representation of an overall arrangement for implementing a transaction using an aerosol provision system configured as described herein. The arrangement comprises an aerosol provision system 10 configured for transmission of an audio signal, and a terminal 40 of a point-of-sale transaction system S. The terminal 40 and the transaction system S may be configured in a variety of ways, such as a dedicated commercial system in a store, restaurant, entertainment venue, etc., where the terminal 40 is configured exclusively or primarily for enabling transactions, or a smaller system in which an electronic device of a second user, such as a mobile telephone, tablet or laptop computer is configured to provide functionality as a terminal and possibly some of the transaction system capability as well. The terminal in effect corresponds to a card reader terminal in a conventional contact and/or contactless payment system using NFC, for example. Indeed, the terminal 40 may be additionally configured for conventional contact and contactless payments, being able to directly read an inserted payment card and/or obtain payment entity information from a presented card or electronic device such as a mobile phone by NFC. This increases the flexibility of the payment system and the number of payment options available for users. The terminal 40 is connected (wirelessly or via a wired connection) to a financial transaction system configured to implement payments made by users of the system, in the usual manner. The financial value of a transaction is input to the terminal 40 (by a payment operative, or by transfer from a till system, for example), and the terminal 40 also receives the payment entity information of a user from, in this case, the user's aerosol provision system 10. These two data are communicated to the transaction system S, and the appropriate debiting of the user's financial asset is implemented. The debited amount is passed to an account, balance or financial asset of a payee of the transaction, typically the entity also operating the point-of-sale terminal 40 (such as a shop, restaurant or similar), so that the payee's identity and account details are known to the transaction system S. Otherwise, the payee information may also be entered into the terminal 40 for communication to the transaction system.

The terminal 40 may include a display screen 42 for presenting information relating to the transaction to the user. This can include, for example, the value of the transaction so the user can check that this is correct before making a payment, instructions on how to implement the payment including how to make the payment using an aerosol provision system with audio communication, and an indication of whether or not a transaction has been successfully completed. Also, the terminal 40 comprises an acoustic receiver or sensor 44 (typically a microphone) which is able to detect the acoustic signal 22 emitted by the aerosol provision system 10. The terminal 40 includes a processor or controller (not shown) configured to process a received and detected acoustic signal 22. This may include decryption and decoding of the acoustic signal 22 in order to extract the payment entity information, which is then sent to the system S for implementation of the transaction. Alternatively, only one of encryption or decoding, or neither, may be carried out at the terminal, with the acoustic signal sent to the system S in a partially processed or entirely raw form, for processing to obtain the payment entity information being carried out by the system itself which is typically located on a server remote from the retail establishment in which the terminal 40 is located.

Operation of the system will now be discussed. When a user wishes to make a payment transaction, an operative of the payment/sales system activates the terminal so that the terminal is ready to receive or accept an input of payment entity information in order to enable the payment. The user manipulates the aerosol provision system 10 in order to cause emission of the required acoustic signal. This may be, for example, by activation, operation or actuation of a user input element 12 on the aerosol provision system 10, which sends a signal to the controller of the aerosol provision system 10 to indicate that the payment entity information is required. The user input element 12 may be a button, a switch, a touch control, a voice input, or any other convenient element, as desired. It may be a dedicated user input element 12 for enabling payments, or may be a multi-function user input element configured for other user input interactions with the aerosol provision system 10. Other approaches may be used to trigger the acoustic signal emission. For example, the aerosol provision system 10 may be configured to receive a signal (acoustic or otherwise) from the terminal 40 that instructs it to initiate acoustic signal emission, or the aerosol provision system 10 may include a proximity sensor (not shown) able to detect that the aerosol provision system has been brought within a certain distance of the terminal 40, when it is considered appropriate to emit the acoustic signal. Other methods apparent to the skilled person may also be used.

Once the aerosol provision system 10 has received an instruction that the acoustic signal is required to enable a payment transaction, the controller functions to supply the drive signal in which the payment entity information is encoded to the speaker of the aerosol provision system 10. The speaker is hence caused to emit the acoustic signal 22. As discussed above, the drive signal can be generated on demand, if the payment entity information is stored in memory in the aerosol provision system. The controller retrieves the payment entity information from the memory in response to the payment transaction instruction, and encodes it into a drive signal in order to generate the required drive signal. Alternatively, this generation can have been carried out in advance and the drive signal also stored in the memory. In this case, the controller retrieves the drive signal from memory and supplies it to the speaker. In another alternative, the drive signal itself may be generated externally, and is provided to the aerosol provision system and stored for use as required, rather than the payment entity information being stored in the aerosol provision system. For example, a mobile telephone, computing device or other electronic device of the user may be configured to have access to the payment entity information and generate the drive signal from the payment entity information, before delivering the drive signal to the aerosol provision system as part of configuring the aerosol provision system for carrying out payment transactions. This can simplify the computer processing required to be performed by the aerosol provision system itself. The drive signal may be delivered via any communication arrangement for which the aerosol provision system is required, wired or wireless (for example, Ethernet, USB, Wi-Fi, mobile telecommunications). As another example, the aerosol provision system may be configured to receive acoustic signals in addition to transmitting acoustic signals. In this case, the acoustic signal itself may be broadcast from an external device (such as a mobile telephone which is inherently configured with a speaker of its own), detected by the aerosol provision system and converted back to the original drive signal for storage and future supply to the speaker of the aerosol provision system. In any arrangement for producing and supplying the drive signal to the speaker, encryption may be utilised as described above if desired.

The acoustic signal 22 is emitted by the speaker of the aerosol provision system, and propagates to the terminal 40 where it is detected by the microphone or other audio detector 44. It is envisaged that the aerosol provision system 10 will be relatively close to the terminal, since the user is present to have initiated the need for the transaction in the first place. For example, the aerosol provision system 10 will likely be within 1 m or within 50 cm of the terminal. Hence, the acoustic signal 22 need not have a high volume in order to be perceptible by the audio detector 44. However, in order to avoid confusion with or interference from other sounds propagating in the vicinity of the terminal, the acoustic signal may, for example, be configured to include identifying information that indicates that it is a payment entity information encoded acoustic signal. Such information may be included in a header portion of the acoustic signal, for example. The processor of the terminal 40 is then configured to find the header so that it is known that subsequent sound detected comprises the required acoustic signal. Similarly, the acoustic signal may include a footer portion having a signal indicating that the relevant portion of the acoustic signal which carries the payment entity information has finished.

Alternatively or additionally, the acoustic signal can occupy only a single frequency or narrow frequency band, and the terminal can include one or more acoustic filters configured to separate the detected acoustic signal at this frequency or frequencies from other detected sound such as background noise. The filtering may be achieved with dedicated filtering components, or may be achieved during processing of the detected signal.

Once the acoustic signal 22 has been received by the terminal 40, the payment entity information encoded in the acoustic signal 22 is passed by the terminal 40 to the main part of the payment system S together with other information required to perform the transaction, such as the financial value of the transaction. This can be carried out in line with existing methods used for implementing payment transactions electronically. As discussed above, the payment entity information may be completely or partially extracted from the acoustic signal 22 by the terminal 40, and sent to the main part of the system S, or the raw acoustic signal data can be sent to the system S for remote processing and retrieval of the payment entity information.

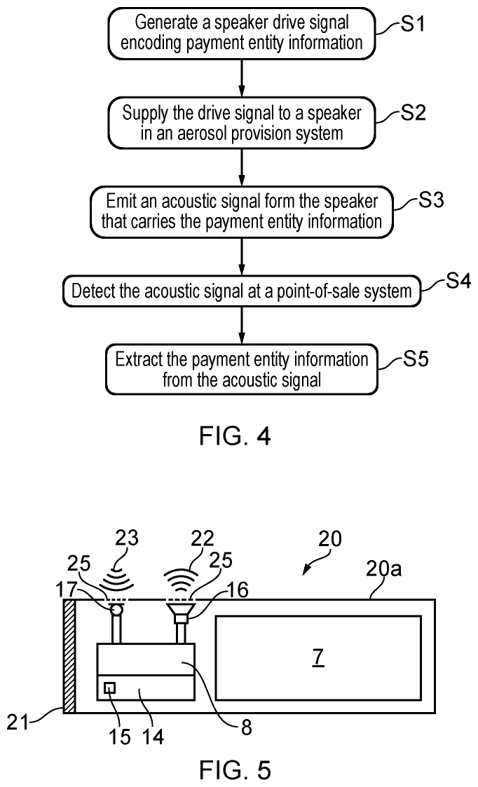

FIG. 4 shows a flow chart of steps in an example method for enabling a transaction according to the current disclosure. In step S1, a drive signal for a speaker in an aerosol provision system is generated, the drive signal encoding payment entity information relating to a payment entity associated with a user. As discussed above, the generation of the drive signal may be performed in demand when a transaction is requested, or may be performed in advance with the drive signal stored for later use. It may generated by the aerosol provision system itself, or generated externally and delivered to the aerosol provision system for immediate or later use. In a second step S2, the drive signal is supplied to the speaker in the aerosol provision system, in response to a transaction requirement. This requirement may be indicated to the aerosol provision system by user operation of a user input element, or the receipt of a transaction trigger or initiation signal sent to the aerosol provision system, for example. In the next step S3, the speaker, in response to the drive signal, emits an acoustic signal carrying the payment entity information. In step S4, the acoustic signal is detected by a point-of-sale terminal of an electronic payment or transaction system operable to transfer a payment from a financial asset of the user to a financial asset of the payee of the transaction. In a last step S5, the payment entity information is extracted from the acoustic signal. This can be done either by the point-of-sale terminal or by the transaction system itself, or shared between the two. The recovered payment entity information is thereby obtained by the transaction system in order for the transaction to be carried out.

The primary purpose of the acoustic signal is to deliver the payment entity information to the transaction system. Hence, the acoustic signal encodes the payment entity information. However, the acoustic signal is not limited in this way, and may also encode other data or information related to the transaction that is made available to the aerosol provision system (either in its own right, or in the form of an already-encoded speaker drive signal generated externally and provided to the aerosol provision system). Such data can include, for example, the value of the transaction, other information about the user or the payment entity, or information about the payee and the payee's financial entity or asset. Data to be included can be selected according to the transacting procedure which is utilised by the transaction system.

FIG. 5 shows a simplified schematic cross-sectional view of a further example device component, in which, as before, elements not related to the present disclosure are omitted for clarity. As with the FIG. 2 example, the device component 20 comprises a housing 20a within which are located a battery 7, a controller 8 with associated data storage 14 storing payment entity information 15, and a speaker 16 connected to the controller for the receipt of drive signals to cause the speaker 16 to emit an acoustic signal 22. Additionally, the device component also includes an acoustic detector 17 such as a microphone also housed inside the housing 20a and connected to the controller. This allows the device 23 to engage in two-way acoustic communication, since the microphone 17 can detect incoming acoustic signals 23 broadcast from external entities, and deliver detected acoustic signals to the controller 8 for processing. Detected acoustic signals can carry data or information encoded therein, and processing by the controller 8 can extract that information and use it in control of the aerosol provision system. Usefully, the same coding scheme can be used for incoming acoustic signals as is used to encode the payment entity information 15 into the emitted acoustic signal 22. This provides simplicity and reduces the amount of coding instructions required by the controller 8. However, different schemes may be used for the outgoing and incoming communication channels if preferred. Similarly, incoming acoustic signals 23 may be encrypted, as discussed for the emitted signals 22, and the controller 8 can be configured to decrypt them.

In this example, each of the speaker 16 and the microphone 17 is positioned behind a window 25 in the wall of the housing 20a which reduces attenuation of the acoustic signals 22, 23. The windows may be simple apertures or may be covered with a grill, mesh or similar or comprise a plurality of holes, for example.

In use for making or arranging a transaction or being configured for transaction capability, the aerosol provision system may receive acoustic signals from an external electronic device such as a mobile phone. Also, it may receive acoustic signals from the point-of-sale terminal when a transaction is being carried out. For example the point-of-sale terminal may emit a start signal or an initiation signal when a transaction has been set up and the terminal is ready to receive the acoustic signal carrying the payment entity information. When the aerosol provision system receives the start signal, it arranges for emission of the acoustic signal carrying the payment entity information from the speaker, by supplying the drive signal to the speaker. As another example, the point-of-sale terminal may send an acoustic positive reply signal to the aerosol provision device to inform the aerosol provision device that it has successfully received the acoustic signal carrying the payment entity information. Additionally, the point-of-sale terminal may send a negative reply signal to the aerosol provision device if the acoustic signal carrying the payment entity information has not been successfully received during an expected time frame, for example if it has not been received at all, or only partially received, or cannot be decoded or decrypted or is otherwise corrupted. In response, the controller of the aerosol provision system can cause the speaker to emit the acoustic signal carrying the payment entity information for a second or additional time. Furthermore, the point-of-sale terminal may receive a message from the transaction system indicating the overall success or failure of the transaction. The point-of-sale terminal can emit a corresponding acoustic signal to convey an indication of success or failure to the aerosol provision device, where it is detected by the microphone 17 and passed to the controller 8 for decoding. The device 20 may additionally comprise a user output element 27 which can be activated by the controller in order to convey the outcome of the transaction to the user. For example, the user output element may comprise one or more light emitting diodes (LEDs) or other optical sources, which can be illuminated to indicate the outcome, such as a green (or first colour) LED illuminated to show success and a red (or second colour) LED illuminated to show failure. Alternatively a single LED may be illuminated to show success and kept unilluminated to show failure, or different sequences of pulses or flashes could be used. The user output element might alternatively be a screen on which information can be displayed for presentation to the user. In other examples, an external electronic device, such as the user's mobile telephone, may be utilised as a user output element, to which the device 20 sends a wireless signal (such as by Bluetooth) to cause the external electronic device to indicate or communicate the transaction outcome to the user.

Alternatively, the need for a separate user output element can be removed if the speaker 16 is employed for this purpose. The controller can generate or be provided with suitable drive signals (stored in the memory 14, for example) to cause the speaker to emit sounds indicative of the outcome of the transaction to the user. The sounds could be sequences of one or more tones or beeps, or brief tunes, or noises traditionally associated with success and failure (“fanfare” and “raspberry”, for example), or spoken words. This can also be implemented in response to success or failure notifications from the point-of-sale terminal regarding the initial receipt and processing of the acoustic signal.

The aerosol provision system may be configured to receive information about the transaction from the point-of-sale terminal by other means instead, while still making use of the various options for user output elements as described.

Additionally, it is possible to make use of the speaker to broadcast spoken word commands, instructions and information to the user. This could be used to instruct the user through the transaction, such as explaining how to present the aerosol provision system to the point-of-sale terminal in an optimal manner for successful transmission of the audio signal carrying the payment entity information, and informing the user that the transaction has been successfully completed or not.

The various embodiments described herein are presented only to assist in understanding and teaching the claimed features. These embodiments are provided as a representative sample of embodiments only, and are not exhaustive and/or exclusive. It is to be understood that advantages, embodiments, examples, functions, features, structures, and/or other aspects described herein are not to be considered limitations on the scope of the invention as defined by the claims or limitations on equivalents to the claims, and that other embodiments may be utilised and modifications may be made without departing from the scope of the claimed invention. Various embodiments of the invention may suitably comprise, consist of, or consist essentially of, appropriate combinations of the disclosed elements, components, features, parts, steps, means, etc., other than those specifically described herein. In addition, this disclosure may include other inventions not presently claimed, but which may be claimed in the future.

1. A device component for an aerosol provision system, the device component comprising:
a speaker operable to emit acoustic signals; and
a controller configured to:
supply to the speaker a drive signal in which is encoded payment entity information relating to a payment entity associated with a user, to cause the speaker to emit an acoustic signal carrying the payment entity information for detection by a point-of-sale payment transaction system.

2. A device component for an aerosol provision system according to claim 1, further comprising:
data storage for storing the payment entity information; and
wherein the controller is further configured to generate the drive signal by encoding the payment entity information into the drive signal.

3. A device component for an aerosol generating system according to claim 2, wherein the controller is further configured to store the drive signal in the data storage for subsequent supply to the speaker.

4. A device component for an aerosol provision system according to claim 1, wherein the controller is further configured to encrypt the drive signal before supplying it to the speaker, using a key associated with the point-of-sale system.

5. A device component for an aerosol provision system according to claim 2, wherein the controller is further configured to encrypt the payment entity information before encoding the payment entity information into the drive signal.

6. A device component for an aerosol provision system according to claim 1, wherein the drive signal is configured to cause the speaker to emit the acoustic signal carrying the payment entity information in an ultrasonic frequency range.

7. A device component for an aerosol provision system according to claim 1, wherein the drive signal is configured to cause the speaker to emit the acoustic signal carrying the payment entity information in an audible frequency range.

8. A device component for an aerosol provision system according to claim 1, wherein the device component further comprises a user input element, in response to the activation of which by the user, the controller causes the speaker to emit the acoustic signal carrying the payment entity information.

9. A device component for an aerosol provision system according to claim 1, wherein the device component further comprises a microphone operable to detect acoustic signals and deliver detected acoustic signals to the controller.

10. A device component for an aerosol provision system according to claim 9, wherein the microphone is operable to detect and deliver acoustic signals carrying information emitted by a point-of-sale system.

11. A device component for an aerosol provision system according to claim 10, wherein the controller is further configured to cause the speaker to emit the acoustic signal carrying the payment entity information in response to detection of an acoustic signal from the point-of-sale system.

12. A device component for an aerosol provision system according to claim 10, wherein the controller is further configured to recognise detection of acoustic signals from the point-of-sale system which carry information regarding an outcome of a payment transaction.

13. A device component for an aerosol provision system according to claim 12, wherein the information regarding an outcome of a payment transaction comprises any of an indication of successful receipt of the acoustic signal carrying the payment entity information by the point-of-sale system, an indication of failure to receive the acoustic signal carrying the payment entity information by the point-of-sale system, an indication of successful completion of the payment transaction, and an indication of failure to complete the payment transaction.

14. A device component for an aerosol provision system according to claim 12, further comprising a user output element, the controller configured to activate the user output element to indicate the information regarding an outcome of a payment transaction carried in an acoustic signal received from the point-of-sale system, in order to notify the information regarding an outcome of a payment transaction to the user.

15. A device component for an aerosol provision system according to claim 14, wherein the speaker is configured as the user output element.

16. An aerosol provision system comprising a device component according to claim 1.

17. An aerosol provision system according to claim 16, comprising an article comprising an aerosol generator, the controller further configured to control the aerosol generator to generate aerosol for consumption by the user in response to user demand for aerosol.

18. An aerosol provision system according to claim 17, wherein the device component and the article are separably connectable to one another to form the aerosol generating system.

19. A method of enabling a payment transaction, comprising:
generating a drive signal for a speaker in an aerosol provision system, in which is encoded payment entity information relating to a payment entity associated with a user;
supplying the drive signal to the speaker to cause the speaker to emit an acoustic signal carrying the payment entity information;
detecting the acoustic signal at a point-of-sale system; and
extracting the payment entity information from the acoustic signal.

20. A method according to claim 19, further comprising:
storing the payment entity information in data storage comprised in the aerosol provision system; and
retrieving the payment entity information from the data storage in order to generate the drive signal.

21. (canceled)
